(19) United States
(12) Patent Application Publication
(10) Pub. No.: US 2012/0226823 A1
(43) Pub. Date: Sep. 6, 2012

(54) DOCUMENT DISTRIBUTION SYSTEM AND METHOD

(75) Inventors: Noam LIVNAT, Ramot Meir (IL); Zvi STACHEL, Petah-Tiqwa (IL); Uri SHAKED, Ramat-Gan (IL)

(73) Assignee: CONFIDELA LTD, Petah-Tiqwa (IL)

(21) Appl. No.: 13/474,089

(22) Filed: May 17, 2012

Related U.S. Application Data
(63) Continuation-in-part of application No. 12/249,934, filed on Oct. 12, 2008.
Application No. 12/249,934 is a continuation-in-part of application No. 12/249,937, filed on Oct. 12, 2008.
(60) Provisional application No. 61/487,717, filed on May 19, 2011.

(51) Int. Cl. G06F 15/16

(52) U.S. Cl. 709/246

(57) ABSTRACT

A computer implemented method for document distribution, the method comprising steps the computer is programmed to perform, the steps comprising: on a networked computer, receiving a document from a sender and authorization data defining at least one authorized recipient for the document, the sender and the authorized recipient being remote from the networked computer, for at least one of the authorized recipients, selecting at least one respective optimal format among a plurality of file formats, converting the received document into the selected format, and distributing the converted document to the authorized recipient.

### RELATIONSHIP TO EXISTING APPLICATIONS

The present application claims priority from U.S. Provisional Patent Application No. 61/487,717 filed on May 19, 2011, and is a continuation in part of U.S. patent application Ser. No. 12/249,937 filed on Oct. 12, 2008, and a continuation in part of U.S. patent application Ser. No. 12/249,934 filed on Oct. 12, 2008, the contents of which are hereby incorporated by reference.

### FIELD AND BACKGROUND OF THE INVENTION

The present invention relates to document processing, and more particularly, but not exclusively to a system and a method for document distribution.

In any modern organization, countless documents in a variety of formats, such as Microsoft® PowerPoint presentations, Microsoft® Word documents, Microsoft® Excel spreadsheets, Portable Document Format (PDF) documents, Joint Photographic Experts Group (JPEG) image files, etc., are generated during the normal course of running the modern organization. The generated documents are then distributed among selected recipients.

Document distribution has thus become a key subject for any modern organization.

### SUMMARY OF THE INVENTION

According to one aspect of the present invention there is provided a computer implemented method for document distribution, the method comprising steps the computer is programmed to perform, the steps comprising: on a networked computer, receiving a document from a sender and authorization data defining at least one authorized recipient for the document, the sender and the authorized recipient being remote from the networked computer, for at least one of the authorized recipients, selecting at least one respective optimal format among a plurality of file formats, converting the received document into the selected format, and distributing the converted document to the authorized recipient.

According to a second aspect of the present invention there is provided a computer readable medium storing computer executable instructions for performing steps of document distribution, the steps comprising: on a networked computer, receiving a document from a sender and authorization data defining at least one authorized recipient for the document, the sender and the authorized recipient being remote from the networked computer, for at least one of the authorized recipients, selecting at least one respective optimal format among a plurality of file formats, converting the received document into the selected format, and distributing the converted document to the authorized recipient.

According to a third aspect of the present invention there is provided an apparatus for document distribution, the apparatus comprising: a networked computer, a document receiver, implemented on the networked computer, configured to receive a document from a sender and authorization data defining at least one authorized recipient for the document, the sender and the authorized recipient being remote from the networked computer, a format selector, in communication with the document receiver, configured to select at least one respective optimal format among a plurality of file formats, for at least one of the authorized recipients, a document converter, in communication with the format selector, configured to convert the received document into the selected format, and a document distributer, in communication with the document converter, configured to distribute the converted document to the authorized recipient.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. The description taken with the drawings making apparent to those skilled in the art how the several forms of the invention may be embodied in practice.

In the drawings:

FIG. 1 is a block diagram schematically illustrating a first exemplary apparatus for document distribution, according to an exemplary embodiment of the present invention.

FIG. 2 is a block diagram schematically illustrating a second exemplary apparatus for document distribution, according to an exemplary embodiment of the present invention.

FIG. 3 is a flowchart schematically illustrating a method for document distribution, according to an exemplary embodiment of the present invention.

FIG. 4 is a block diagram schematically illustrating a document converted into an SWF format, according to an exemplary embodiment of the present invention.

FIG. 5A is a block diagram schematically illustrating a document in a PDF file, according to an exemplary embodiment of the present invention.

FIG. 5B is a block diagram schematically illustrating an annotation optimized PDF file and an index, according to an exemplary embodiment of the present invention.

FIG. 6 is a block diagram of a table illustrating division of a conversion process into parallel jobs, according to an exemplary embodiment of the present invention.

FIG. 7 is a block diagram schematically illustrating a computer readable medium storing computer executable instructions for performing steps of document distribution, according to an exemplary embodiment of the present invention.

### DESCRIPTION OF THE PREFERRED EMBODIMENTS

The present embodiments comprise an apparatus, a method, and a computer readable medium, for document distribution.

Computer users in modern organizations generate and distribute countless documents that need to be viewed or edited by different recipients who receive the documents.

The recipient(s) of any given document may vary with regard to a platform (say a computing device or an application) in use by the recipient, authorization data pertaining to the recipient, organizational data, etc.

Further, a typical recipient may use a variety of computing devices—say a desktop computer when in the office, a laptop computer when in a meeting out of the office, a smart phone when in the recipient's car, etc.

Furthermore, a same recipient may need to present the document to attendees of a meeting on a plasma screen, using a specific meeting room or conference room device—on the one hand, and edit the document on the recipent's tablet computer—on the other hand.

Exemplary embodiments of the present invention realize that a document's format should be optimized according to different platforms in use, authorization levels of recipients, hour or day of distribution of the document, etc.

According to some of the exemplary embodiments, a document (say a word document, a PDF file, etc.) received from a remote sender (say a user who authored the document), is automatically converted into two or more formats, thus preparing the document for distribution to one or more remote recipient(s) that are authorized to receive the document.

To each one of the authorized recipients, the document may be distributed in an optimal format or in a few optimal formats. The optimal format may be selected according to a variety of criterions.

The criterions may based, but are not limited to: a platform in use by the recipient (a computer of a specific model, a screen of a specific size, a specific viewer application, etc.) when the recipient requests the document, a level of authorization assigned to the recipient, a time in which the document is requested (say at off hours vs. during working hours), an intended use (say for printing vs. for viewing on a computer screen), etc.

The principles and operation of a method, an apparatus, and a computer readable medium, according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways.

Also, it is to be understood that the phraseology and terminology employed herein is for the purpose of description and should not be regarded as limiting.

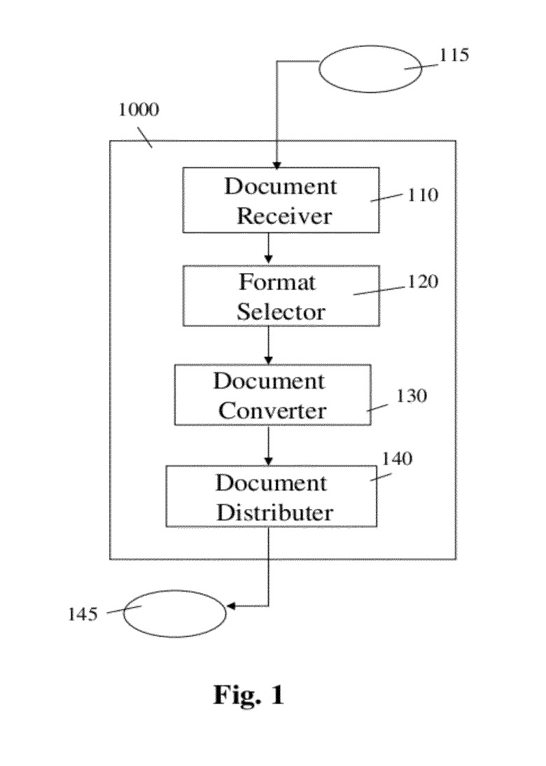

Reference is now made to FIG. 1, which is a block diagram schematically illustrating a first exemplary apparatus for document distribution, according to an exemplary embodiment of the present invention.

An apparatus 1000 for document distribution, according to an exemplary embodiment of the present invention, includes a network computer on which one or more parts 110-140 of the apparatus 1000 are implemented as software, hardware, or a combination of hardware and software, as described in further detail hereinbelow.

The networked computer may be a computer, or a group of computers, which communicates with computers remote from the server computer (through the internet, an intranet, another network, etc.), that are in use by senders 115 and recipients 145 of documents, as described in further detail hereinbelow.

The apparatus 1000 includes a document receiver 110.

The document receiver 110 receives a document (say a textual file, a spreadsheet, etc.) from a sender 115 remote from the networked computer (say a user of a desktop computer in communication with the networked computer), as described in further detail hereinbelow.

The sender 115 may provide the document to the document receiver 110 by sending the document to the networked computer by email, by uploading the document to a library on the networked computer, etc., as known in the art.

In one example, the networked computer is an organizational server computer of the sender's 115 organization.

In the example, the sender 115 communicates with the document receiver 110 implemented on the organizational server computer, over the organization's intranet network, in order to distribute the document to recipients internal to the organization, recipients external to the organization, or both.

In a second example, the networked computer is a server computer of a party that serves as an intermediary between different organizations and computer users.

In the second example, the sender 115 communicates with the document receiver 110 implemented on the intermediary's server computer, over the internet, in order to distribute the document to recipients external to the sender's organization.

The document receiver 110 further receives authorization data.

Optionally, the authorization data is input by the sender 115, by an administrator of the apparatus 1000, by an authorization officer of the sender's 115 organization, or any combination thereof, using a Graphical User Interface (GUI).

The authorization data may define one or more authorized recipients remote from the networked computer.

The apparatus 1000 further includes a format selector 120, in communication with the document receiver 110.

The format selector 120 selects one or more formats optimal for a specific context in which the document is supposed to be distributed to a specific one or more of the recipients 145, according to one or more criterions, as described in further detail hereinbelow.

The format selector 120 selects the optimal format among two or more file formats.

The file formats may differ in file type, such as Microsoft® PowerPoint, Microsoft® Word, Microsoft® Excel, Portable Document Format (PDF), Joint Photographic Experts Group (JPEG), etc. The file formats may also differ in other aspects such as in operations possible with the file format (say a read-only file vs. an editable file), in encryption (or no-encryption) of the format, in watermark data, etc., as described in further detail hereinbelow.

The file formats may further differ in employment of optimization methods such as content compression, indexing, partial rendering of complex objects (say vector graphs) in order to keep the resultant file's size small and avoid content repetition, etc., as known in the art.

The criterions for the format selection may include, but are not limited to:
A sender specific criterion (say that the format belongs to a set of file formats that the remote sender 115 selects or that are selected for the remote sender 115, say by an administrator of the apparatus 1000 as a part of a preliminary procedure in which the sender 115 is registered as a user of the apparatus 1000).
A recipient specific criterion (say that that the format belongs to a set of file formats that the remote recipient 145 selects or that are selected for the remote recipient 145, say by an administrator of the apparatus 1000 as a part of a preliminary procedure in which the recipient 145 is registered as a user of the apparatus 1000).
An organization specific criterion (say that the format belongs to a set of file formats that an administrator of the apparatus 1000, or an authorization officer of an organization, preselects for the organization of the sender 115 before the document receiver 110 starts receiving documents from senders 115 in the organization).
A platform specific criterion (say that the format is optimal for a platform in use by the recipient 145, such as a cellular phone or a tablet computer of a specific model, a screen of a specific size, a specific viewer application, or any combination thereof).

The platform may also include, but is not limited to—a Microsoft® Windows operated Personal Computer, A MacOS™ operated Personal Computer, an iOS operated smartphone (e.g. an iPhone™), an Android operated smartphone (e.g. Samsung© Galaxy phone), an iOS operated tablet (e.g. iPad™), etc.

Some platforms, such as mobile phones, have limited capabilities and may not be able to render all document formats.

The selection of the format may involve identification of a recipient's 145 platform by the format selector 120. The format selector 120 may identify the platform in a variety of ways.

In one example, the format selector 120 identifies the platform using the User-Agent header of an HTTP request from which platform information may be extracted. The HTTP request is used by a recipient 145 to request the document.

The User-Agent header may serve for identification of both a client application and a computing device in use by the recipient 145, as well as of the device's operating system version and capabilities, as known in the art.

In another example, the format selector 120 identifies the platform using parameters reported by a client application downloaded to the recipient's 145 device, say a secure web application tailored specifically for viewing documents distributed to users of apparatus 1000 (i.e. recipients 145), as described in further detail hereinbelow.
A location specific criterion, say that the format is optimal for a specific country that a recipient 145 is located in when the recipient 145 requests the document. For example, documents bearing Japanese fonts may prove problematic when a Microsoft® Word document is sent to a computer located in a country where computer users are less likely to have Japanese fonts installed on their computers. A JPEG image file may serve as a better alternative.
A time specific criterion (say that the format is optimal for document distributed in a time frame predefined by a system administrator, say an editable file for working hours vs. a read-only file for off hours).
An authorization specific criterion (say that the format supports only operations that are within an authorization level pre-assigned to the recipient 145 by the sender 115 or by the administrator of the apparatus 1000, say as a part of a preliminary procedure in which the recipient 145 is registered as a user of the apparatus 1000).
Other criteria, as described in further detail hereinbelow.

The apparatus 1000 further includes a document converter 130, in communication with the format selector 120.

The document converter 130 converts the document into the one or more formats selected for the recipient(s) 145 of the document, by the format selector 120.

In one example, the document converter 130 converts the document into the selected format in one stage, say immediately upon receipt of the document or soon thereafter, or upon receipt of a request to receive the document from a specific recipient or detection of a specific recipient's attempt to download the document.

In another example, the document converter 130 converts the received document in two stages.

The first stage is performed immediately upon receipt of the document or soon thereafter. In the first stage, the document converter 130 converts the document into one or more intermediate format(s), say into one or more formats used as a general default which does not depend on any of the criterions described in further detail hereinabove, into several formats that pertain to different platforms, etc.

The second stage is performed only upon receipt of a request to receive the document from a specific recipient, or upon detection of a specific recipient's attempt to download the document. In the second stage, the document converter 130 converts the document from the intermediate format into the format selected for the specific recipient 145, as described in further detail hereinbelow.

Optionally, the apparatus 1000 further include two or more format-specific converters (not shown), in communication with the document converter 130, as described in further detail hereinbelow.

Each of the format-specific converters converts the received document into a respective one of the selected formats. The document converter 130 may coordinate parallel conversion of the received document into the selected formats, by the format-specific converters, as described in further detail hereinbelow.

Optionally, the document is received in a format which already includes one or more security mechanisms, say as a secured PDF file, as know in the art. The security mechanism may protect the content of received document from being decoded, parsed, processed or displayed without the knowledge of a secret key or by another protection mechanism.

In order to enable the conversion of the document received in the format which includes the security mechanism, the apparatus 1000 may further include one or more security mechanism specific neutralizers, in communication with the document converter 130.

Each security mechanism specific neutralizer neutralizes a specific one of the security mechanisms, as described in further detail hereinbelow.

Optionally, the security mechanism specific neutralizer uses the document receiver 110, for interacting with the document's sender 115 and receiving an encryption key, a file password, or another credential needed to open the document for conversion by the document converter 130, as described in further detail hereinbelow.

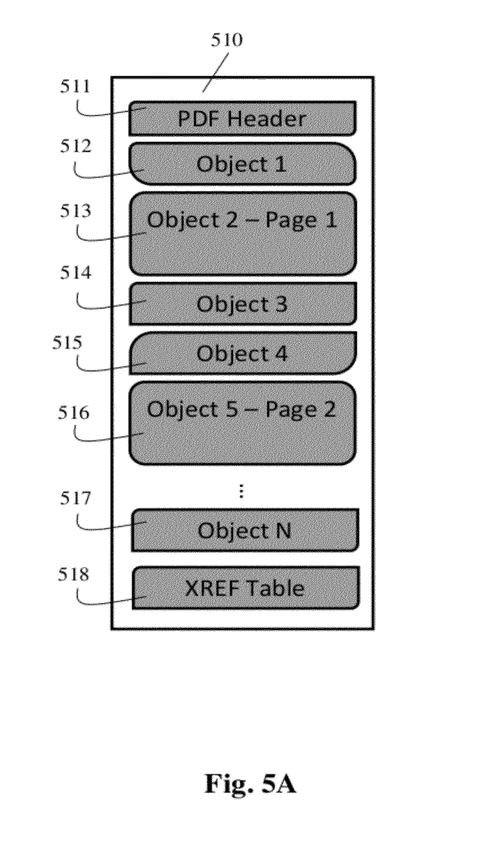

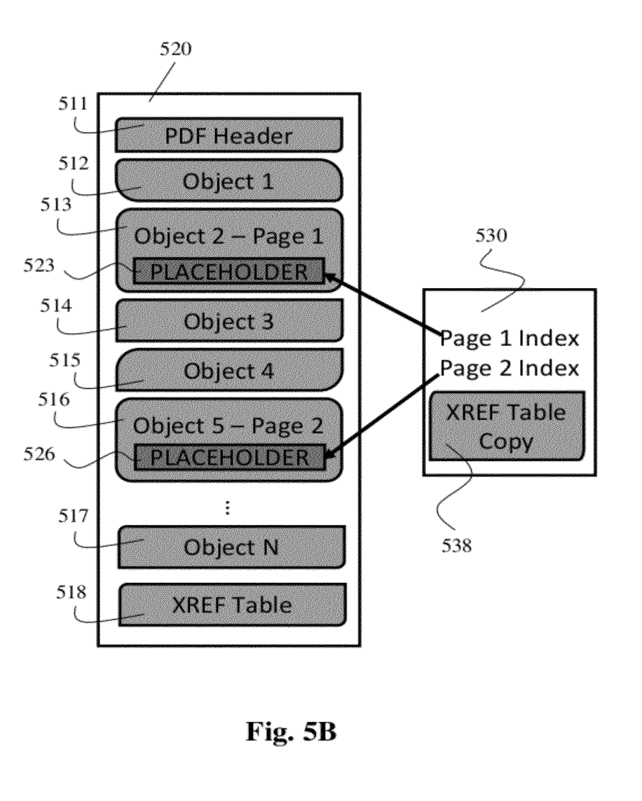

Optionally, the document converter 130 further generates an annotation-free file and one or more respective annotation files (say a different annotation file per each recipient 145) from the received document. In one example, the annotation-free file is an annotation optimized file which includes the received document's content cleaned from annotations, as well as one or more annotation placeholders, as illustrated for the annotation optimized PDF file, using FIG. 5B, and described in further detail hereinbelow.

Similarly, the document converter 130 may further generate a file with one or more watermark placeholders from the received document, say by inserting watermark placeholder at specific parts of the document, thus creating a watermark optimized file, as described in further detail hereinbelow.

Optionally, when a specific recipient requests the document, the document converter 130 may place a recipient specific watermark in one or more of the watermark placeholders, as described in further detail hereinbelow.

Optionally, the document converter 130 further adds to the received document, a security layer based on authorization data predefined by the sender 115, say using a GUI. For example, the document converter 130 may encapsulate the document in a file format in which the content of the document is encrypted and can be decrypted only using a special web application, as described in further detail hereinbelow.

The document converter 130 may convert the document either right after the document is received, or only upon receipt of a request from an authorized recipient of the document, as described in further detail hereinbelow.

Optionally, the document converter 130 performs (or coordinates) some of the conversion operations when the document is received by from the sender 115 (or soon there after) and remaining ones of the conversion's operations only upon receipt of a request from an authorized recipient 145, as described in further detail hereinbelow.

In one example, upon receipt of a Microsoft® Word document from User A (a sender 115), the document converter 130 immediately converts the document into a PDF file (as per a temporary format selection based on the sender's 115 default or a general default format set by a system administrator of the apparatus 1000).

In the example, the PDF file is saved in a dedicated database (not shown).

When User B—a recipient 145 authorized by the sender 115, requests to view the document, the conversion of the document continues. The document converter 130 adds an additional layer of security to the PDF file, such as a watermark holding User B's name, a date or time of the User B's request, etc. Finally, User B is allowed to download the PDF file, thus distributing the document to User B, as described in further detail hereinbelow.

Optionally, the document converter 130 may shift dynamically between two (or more) paths of conversion, say in case of an overload or a failure in conversion through one of the paths, as described in further detail hereinbelow.

Apparatus 1000 further includes a document distributer 140, in communication with the document converter 130.

The document distributer 140 distributes the document converted to the selected format to the recipient 145, say by allowing the recipient 145 to download the converted document, by sending the converted document to the recipient 145, etc.

Optionally, the document distributer 140 distributes the document to the recipient 145 upon the recipient's 145 request (say when the recipient 145 clicks on a link in an email message that the sender 115 sends to the recipient 145).

Optionally, the document distributer 140 distributes the document to the recipient 145 automatically, once the document is successfully converted, or later, say as an attachment or a link in an email message that the document distributer 140 sends to the recipient(s) 145.

In one example, a sender 115 uses the apparatus 1000, to distribute the document to a first recipient 145 who uses a desktop computer and a second recipient 145 who uses a smart phone, say an iPhone™. The document converter 130 converts the document into two different formats, say a Microsoft® Word document for the first recipient 145 and a PDF file for the second recipient 145, as selected by the format selector 120, for each respective one of the two recipients 145, according to a device specific criterion.

In a second example, a sender 115 uses the apparatus 1000, to distribute a textual document to different recipients 145 in the sender's 115 organization.

One of the recipients 145 may be a salesperson.

According to information input by an administrator of apparatus 1000, the salesperson needs to receive each document in a PDF format with company logo watermarks (to print), as a Microsoft® PowerPoint Presentation, and as a JPEG image file optimal for a small screen of the salesperson's smart phone.

Another recipient 145 may be the sender's 115 secretary who according to information input by the sender 115, needs to receives all documents in an editable Microsoft® Word format.

Accordingly, upon receipt of a document sent from the sender 115 to the salesperson, the format selector 120 selects the three formats for the salesperson and the document converter 130 automatically converts the received document into three files. Each of the files is in a respective one of the formats selected for the salesperson. Finally, the document distributer 140 sends the three files to the salesperson, thus distributing the document to the salesperson.

The document converter 130 delays the conversion of the document to the format selected 120 for the secretary until the secretary requests the document.

When the sender's secretary requests to download the document from a network computer on which apparatus 1000 is implemented, the format selector 120 selects the Word document format for the secretary. Then, the document converter 130 converts the received document into an editable Word document format. Finally, the document distributer 140 sends the document converted to the editable Microsoft® Word document to the secretary, thus distributing the document to the secretary.

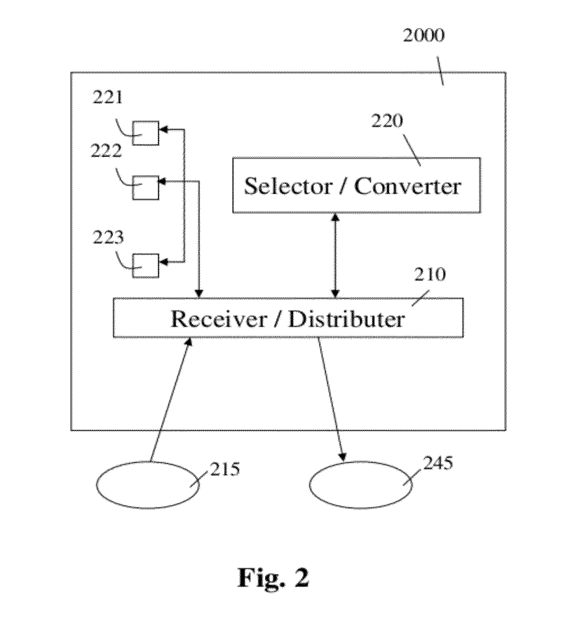

Reference is now made to FIG. 2, which is a block diagram schematically illustrating a second exemplary apparatus for document distribution, according to an exemplary embodiment of the present invention.

An apparatus 2000 for document distribution, according to an exemplary embodiment of the present invention, includes a network computer on which one or more parts 210, 220-223 of the apparatus 2000 are implemented as software, hardware, or a combination of hardware and software, as described in further detail hereinbelow.

The networked computer may be a computer, or a group of computers, which communicates with computers remote from the server computer (through the internet, an intranet, another network, etc.), that are in use by senders 215 and recipients 245 of documents, as described in further detail hereinbelow.

The apparatus 2000 includes a central message bus 210 on which a document receiver is implemented, as described in further detail hereinabove.

The central message bus 210 communicates with remote parties 215, 245, on the one hand, and with internal parts 220 of the apparatus 2000 on the other hand, for receiving and sending messages, documents, etc.

The central message bus 210 may be implemented using communication software and hardware such a modem, a computer communications card, software products that support one or more communication protocols and are installed on the networked computer, etc., or any combination thereof, as known the art.

The document receiver receives a document (say a textual file, a spreadsheet, etc.) from a sender 215 remote from the networked computer (say a user of a desktop computer in communication with the networked computer), as described in further detail hereinbelow.

The sender 215 may provide the document to the document receiver by sending the document to the networked computer by email, by uploading the document to a library on the networked computer, etc., as known in the art.

In one example, the networked computer is an organizational server computer of the sender's 215 organization.

In the example, the sender 215 communicates with the document receiver implemented on the organizational server computer, over the organization's intranet network, in order to distribute the document to recipients 245 internal to the organization, recipients 245 external to the organization, or both.

In a second example, the networked computer is a server computer of a party that serves as an intermediary between different organizations and computer users.

In the second example, the sender 215 communicates with the document receiver implemented on the intermediary's server computer, over the internet, in order to distribute the document to recipients 245 external to the sender's organization.

The document receiver implemented on the central message bus 210, further receives authorization data.

Optionally, the authorization data arrives at the central message bus 210 together with the document—both sent by the remote sender 215.

Optionally, the authorization data is input earlier, say by an administrator of the apparatus 2000, by an authorization officer of the sender's organization 215, or any combination thereof, using a Graphical User Interface (GUI).

The authorization data may define one or more authorized recipients 245 remote from the networked computer, say as a white list (listing authorized recipients), a black list (listing users blocked from being distributed to), that only users of a specific organization are distributed to, say that all users are distributed to, etc.

The apparatus 2000 further includes a message router 220, on which a format selector in communication with the document receiver is implemented.

The format selector selects one or more formats optimal for a specific context in which the document is supposed to be distributed to a specific one or more of the recipients 245, according to one or more criterions, as described in further detail hereinbelow.

In one example, upon arrival of the document to the central message bus 210, the message router 220 picks the document (i.e. file), and the format selector selects one or more formats optimal for a specific context in which the document is supposed to be distributed to a specific one or more of the recipients 245, according to one or more criterions, as described in further detail hereinbelow.

The format selector selects the optimal format among two or more file formats, according to one or more criterions, as described in further detail hereinabove.

The criterions for the format selection may be based, but are not limited: a format type of the document as received, a size of document (say the number of pages or kilobytes), the document's complexity (say a plain text file vs. a file combining text and graphics), a sender specific criterion, a recipient specific criterion, other criterions, or any combination thereof. The other criterions may include an organization specific criterion, a platform specific criterion, a location specific criterion, a time specific criterion, an authorization specific criterion, other criterions, etc., or any combination thereof, as described in further detail hereinbelow.

The apparatus 2000 further includes a document converter, in communication with the format selector, implemented on the message router 220.

The document converter converts the document into the one or more formats selected for the recipient(s) 245 of the document, by the format selector.

Optionally, the apparatus 2000 further include two or more format-specific converters 221-223 in communication with the document converter implemented on the message router 220, say through the central message bus 210.

Each one of the format-specific converters 221-223 may be implemented as one or more software components in execution on the network computer.

Optionally, each one of the format-specific converters 221-223 converts the received document into a respective one of the selected formats, or takes a part in the conversion of the document into the selected format, as described in further detail hereinbelow.

The document converter implemented on the message router 220 coordinates parallel conversion of the received document into the selected formats by the format-specific converters 221-223, thus orchestrating the conversion process.

The document converter forwards a copy of the document to one or more of the format-specific converters 221-223, as per the file formats selected by the format selector.

Optionally, the format converter uses two or more of the format-specific converters 221-223, for converting the document into a specific one of the selected format.

In one example, the conversion is split between two (or more) of the format-specific converters 221-223, such the each of the two (or more) format-specific converters 221-223 carries out a certain part of the conversion. In the example, one format-specific converter converts the document into an intermediate format, and the other format-specific converter converts the document from the intermediate format into the format selected for a specific recipient 245 of the document.

In another example, the document is a large one, and the format converter splits the conversion process, such that half of the document is converted by one of the format-specific converters 221-223, and the other half is converted by a second one of the format-specific converters 221-223. In the example, both format-specific converters 221-223 convert the document into a same format, and the document converter merges the two converted halves into a single document (i.e. the complete converted format).

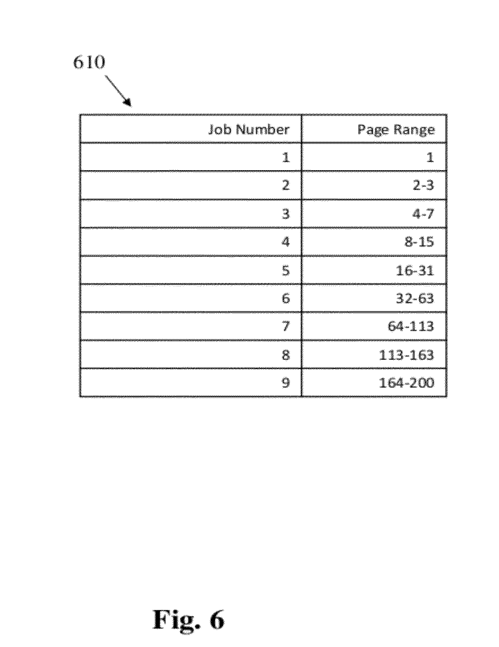

Similarly, the format converter may split the conversion among several format-specific converters 221-223, as described in further detail hereinbelow, and illustrated using FIG. 6.

Optionally, the format-specific converters 221-223 communicate with the document converter, using the central message bus 210, through an out-of-band channel, such as a HTTP channel, an FTP channel, etc.

Each format-specific converter may receive the document (or a part thereof), as well as outputs of another one of the format-specific converters 221-223.

Each format-specific converters may output the document in a converted format (be it an intermediate format or the format selected by the format selector) as well as information extracted from the document, say meta-data, or any other technical information such as size, etc.

Optionally, once a format-specific converter 221-223 finishes converting, the format-specific converter 221-223 sends a completion message to the central message bus 210. The completion message is picked by the document converter implemented on the message router 220.

The document converter determines whether the document needs further processing by another format-specific converter 221-223, in which case the document converter forwards the document to the other format-specific converter 221-223, for further conversion.

It is noted that the document may optionally be received in a format which includes one or more security mechanisms, say as a secured PDF file, as know in the art. The security mechanism may protect the content of received document from being decoded, parsed, processed or displayed without the knowledge of a secret key or another credential, as described in further detail hereinbelow.

Consequently, in order to convert the received document into one or more of the selected formats, the document converter 220 may further neutralize the security mechanisms, so as to enable all necessary operations that form a part of the conversion of the received document.

Optionally, the apparatus 2000 further includes one or more security mechanism specific neutralizers, say dedicated software components, in communication with the document converter.

Each security mechanism specific neutralizer enables the apparatus 2000 to deal with a specific protection mechanism, thus enabling the conversion of the document received protected by the security mechanisms.

In one example, the neutralizing of the security mechanisms involves interaction with the sender 215 of the document, for receiving an encryption key, a file password, or whatever other credential needed to successfully open the document (say by decrypting the secured PDF format), for the conversion into the selected formats.

Apparatus 2000 further includes a document distributer, in communication with the document converter. The document distributer is implemented on the central message bus 210.

The document distributer distributes the document converted into the selected format to the recipient 245, say by allowing the recipient 245 to download the converted document, by sending the converted document to the recipient 245 in an email message, etc.

Optionally, the document distributer distributes the document to the recipient 245 upon the recipient's 245 request (say when the recipient 245 clicks on a link in an email message that the sender 215 sends to the recipient 245).

Optionally, the document distributer 240 distributes the document to the recipient 245 automatically, once the document is successfully converted, or later, say as an attachment or a link in an email message that the document distributer sends to the recipients 245.

The message router 220 may be configured with message wiring configuration data, which pertains to communication between the parts of the apparatus 2000. Consequently, the apparatus 2000 may be dynamically wired in a variety of ways, allowing addition, modification, configuration and removal of different parts of the apparatus 2000 (say different format-specific converters 221-223) while in running.

Optionally, the message router 220 also sends notification messages on status of the conversion, to one or more parts of the apparatus 2000.

In one example, the document receiver may receive a notification message from the document converter implemented on the message router 220. The notification message indicates that the conversion for the document is finished. Consequently, the document receiver may forward the message to a document's sender 215, say in an email message.

Optionally, the apparatus 2000 further includes a system manager (not shown) implemented on the network computer (say on a specific computer in a group of computers that form the network computer).

The system manager monitors the utilization of the various parts 210, 220-223 of the apparatus 2000, the workload level on each part, the performance of each part, the number of unprocessed messages (say documents) in different message queues specific to each of the parts 210, 220-223, etc.

Upon detecting a high workload condition, the system manager may start one or more additional parts, say an additional format-specific converter 221-223.

The way in which the system manager starts the additional part may vary.

In one example, the system manager launches a new Virtual Machine or a Virtual Private Server (VPS) instance, and starts a new format-specific converter 221-223, as known in the art. Then, the system manager configures the format-specific converters 221-223 to connect to the central message bus 210 and to start consuming documents forwarded to the additional format-specific converter, by the document converter, as described in further detail hereinabove.

The system manager may also send automated alerts to operators of the apparatus 2000, by Email, SMS (Short Message Service), etc., as known in the art. The alerts inform the operators on the high workload condition.

Optionally, when the workload of the apparatus 2000 returns to normal, the system manager disconnects and stops the part started due to the high workload, thus reducing operational costs of the apparatus 2000.

Optionally, the central message bus 210 further supports message prioritization. For example, the document receiver may assign a different priority to each document. Consequently, the document converter may forward documents of higher priority to the format-specific converters 221-223 before documents of lower priority.

The document receiver may assign the priorities to the documents according to a variety of prioritization criteria.

The criteria may include, but is not limited to: document size (say number of pages or kilobytes), document format, document complexity (say text vs. graphics), the sender 215, the sender's 215 organization, the application used by the sender 215, the number of documents sent by the sender 215, etc., or any combination thereof.

The document receiver 215 may also use other criterions such as a current workload and capacity of the different parts of the apparatus 2000.

In some cases, the process of converting the document from one format to another may fail. Such failures may have a variety of reasons, including, but not limited to: invalid, incorrect or incomplete document format, damaged data, temporary computer errors such as out of disk space/memory condition, content which cannot be represented in the selected format, etc., as known in the art Conversion failures may be divided into two different categories: temporary failure—such as a failure caused by an out of disk space condition, and permanent failure—such as a document in an invalid file or a password protected document that cannot be opened, as know in the art.

Optionally, a temporary failure may be overcome by the document converter, by forwarding the received document to a different format-specific converter 221-223.

Optionally, a permanent failure may be overcome by the document converter, using alternative conversion paths that may be defined by an administrator of the apparatus 2000.

The administrator may define two or more alternative paths for converting a document from a specific first format to a specific second format (say a path that uses an intermediate file format instead of direct conversion of the document into the second format), as described in further detail hereinbelow.

Consequently, the document converter may shift dynamically between two or more of the different paths defined by the administrator for converting the document from the specific first format to the specific second format, thus using the second path as a fallback, say in case of a permanent failure in conversion through the first path.

In a first example, the administrator may define that in case of a failure in conversion of a Microsoft® Word document into a PDF format using Microsoft®Office, the document is converted into a file in an RTF (Rich Text Format) format first, and the RTF format file is converted into the PDF format.

The administrator may further define an alternative path in which the Microsoft® Word document is printed into a PDF Printer from the Microsoft® Word application, and the PDF Printer's driver output constitutes the PDF format.

Another example involves a failure in conversion of a PDF document into SWF format, due to presence of too many objects in the PDF document.

The failure results from the fact that SWF files have an inherent limitation which allows only as much as 65,536 shape objects to be defined in a single SWF file.

The administrator may define an alternative path in which multiple shape objects are combined into a single image, thus having fewer shape objects in the Flash player file format, as described in further detail hereinbelow.

Optionally, the document converter further identifies the reason for a permanent failure and reports the failure and reason to the document receiver, which in turn, reports the failure to the sender 215, say in an SMS or email message.

Optionally, the document receiver further interacts with the sender 215, for receiving information that may help overcome the failure.

In one example, a failure may occur due to a document password based protection mechanism, as described in further detail hereinabove.

Upon occurrence of the failure, the document receiver asks the sender 215 to provide the password.

Once the document receiver receives the password, the document receiver (or the document converter) uses the password to open the document, and the document converter successfully converts the document into the selected format.

The apparatus 2000 may process a large number of documents, using several format-specific converters 221-223, in a process orchestrated by the document converter.

If one of the format-specific converters 221-223 fails and goes offline without being noticed, documents that need to be processed may end up waiting in vain, for the format-specific converter 221-223 to convert them.

The apparatus 2000 may further include a monitor, implemented on the networked computer.

The monitor periodically sends one or more test documents to the central message bus 210, as if the monitor is one of the remote senders 215.

The test documents are used by the monitor, to simulate common use cases that involve conversion by one or more of the format-specific converters 221-223. The monitor analyses the conversion results, and makes sure the document are successfully converted into properly selected formats.

Based on the results of the conversion of the test documents, the monitor may report on any failure, say that a conversion into a specific file format fails repeatedly.

Further, the monitor may try to work around some of the failures, say by starting an additional format-specific converter, similarly to the system manager, as described in further detail hereinabove. The additional format-specific converter handles the workload until a system administrator is available to discover the exact reason of the failure.

Optionally, the monitor may have an upgrade mode, which pertains to a time in which one or more parts 210, 220-223 of the apparatus is upgraded. When in the upgrade mode, whenever a failure is detected by the monitor, the monitor automatically rolls the apparatus 2000 back to a stable mode of before the upgrade, as known in the art.

Optionally, apparatus 2000 further includes a real-time reporter (not shown) implemented on the networked computer.

The real-time reporter reads status messages (say from specific message queues managed by the central message bus 210) that are sent by one or more parts of the apparatus 2000, say by the different format-specific converters 221-223.

In one example, the format selector selects a few formats for a received document, to be converted into. Upon completion of conversion to a first one of the formats, a converter 221-223 specific to the format, sends a completion message to the document converter.

The real-time reporter reads the message from a message queue on the central message bus 210. Than, the real-time reporter forwards the message to the document receiver, which in turn, informs the sender 215 of the document on successful completion of a specific part of the conversion (i.e. of the part of conversion to the first format).

The real-time reporter may forward the message to other parts of the apparatus 2000 too.

Optionally, the real-time reporter reports on the completion of the specific part of the conversion in real time (even before other parts of the conversion are completed successfully). Consequently, the user experience of apparatus 2000 may be improved.

For example, a remote recipient 245 for whom the format selector selects several formats (say the salesperson of the example provided and discussed in further detail hereinabove) may download the document in the (already available) first format. The recipient 245 may download the document in the first format, while the conversion of the document into the other formats selected for the recipient 245 continues.

In another example, the apparatus 2000 further includes a central log manager (not shown), implemented on the networked computer, say on the central message bus 210.

The central log manager receives log messages from one or more parts of the apparatus 2000, and merges the log messages into a central log. The central log may be used for problem diagnosis, detection of abnormal use of the apparatus 2000 by certain senders 215 or recipients 245 (say by hackers or spammers), as known in the art.

Optionally, the central log manager receives the log messages from the real-time reporter when the real-time reporter identifies one or more of the messages that the real-time reporter reads from the messages queue, as relevant for logging.

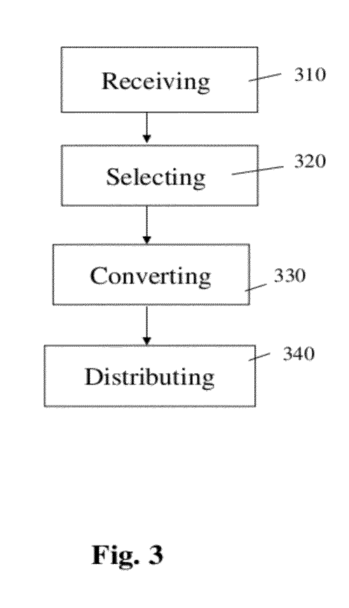

Reference is now made to FIG. 3, which is a flowchart schematically illustrating a method for document distribution, according to an exemplary embodiment of the present invention.

An exemplary method according to an exemplary embodiment of the present invention may be implemented on a networked computer which is used as a server computer.

The networked computer may be a computer (or a group of computers) which communicates with computers remote from the networked computer (through the internet, an intranet network, another network, etc.), that are in use by senders and recipients of documents, as described in further detail hereinbelow, and illustrated in FIG. 1.

In the exemplary method, there is received 310 a document (say a textual file, a spreadsheet, etc.) from a sender remote from the networked computer (say a user of a desktop computer in communication with the networked computer), say by the document receiver 110, as described in further detail hereinbelow.

The sender may provide the document by sending the document to the networked computer by email, by uploading the document to a library on the networked computer, etc., as known in the art.

In one example, the networked computer is an organizational server computer of the sender's organization. In the example, the sender sends the document to the server computer, over the organization's intranet network, in order to distribute the document to recipients internal the organization, to recipients external to the organization, or both.

In a second example, the networked computer is a server computer of a party that serves as an intermediary between different organizations or computer users. In the second example, the sender sends the document over the internet, to the intermediary's server computer, in order to distribute the document to recipients external to the sender's organization.

In the method, there is further received 310 authorization data, say by the document receiver 110.

The authorization data may be input by an administrator of the apparatus 1000, an authorization officer of the sender's organization, etc., or any combination thereof, say using a Graphical User Interface (GUI).

The authorization data may define one or more authorized recipients remote from the networked computer, as described in further detail hereinabove.

Next, there are selected 320 one or more formats optimal for a specific context in which the document is distributed or supposed to be distributed to a specific one or more of the recipients, according to one or more criterions, as described in further detail hereinabove.

Optionally, the optimal formats are selected 320 by the format selector 120, as described in further detail hereinabove.

The optimal formats are selected 320 among two or more file formats.

The file formats may differ in file type, such as Microsoft® PowerPoint, Microsoft® Word, Microsoft® Excel, Portable Document Format (PDF), Joint Photographic Experts Group (JPEG), etc.

The file formats may also differ in other aspects such as in operations possible with the file format (say a read-only file vs. an editable file), in encryption (or non-encryption) of the format, in watermark data embedded in the format, etc., as described in further detail hereinbelow.

The file formats may further differ in employment of optimization methods such as content compression, indexing, partial rendering of complex objects (say vector graphs) in order to keep the resultant document's size small and avoid content repetition, etc., as known in the art.

The criterions for the format selection may include, but are not limited to:
A sender specific criterion (say that the format belongs to a set of file formats that the remote sender selects or that are selected for the remote sender, say by an administrator of the apparatus 1000).
A recipient specific criterion (say that that the format belongs to a set of file formats that the remote recipient selects or that are selected for the remote recipient, say by an administrator of the apparatus 1000).

For example, the recipient may specifically request to retrieve a specific PDF document to which annotations by another user of the apparatus 1000 (say another recipient of the document) are added, as described in further detail hereinbelow.
An organization specific criterion (say that the format belongs to a set of file formats that an administrator of the apparatus 1000, or an authorization officer of an organization, selects for the organization of the sender, or that certain formats are only allowed for recipients who use a computing device or an IP Address listed as belonging to a specific organization).
A platform specific criterion (say different hardware in use by the recipient, such as a cellular phone of a specific model, a screen of a specific size, a specific viewer application, or different software components, such as—a Microsoft® Windows operating System, A Mac™ OS operating System, an iOS Operating System (say on an iPhone™), an Android Operating System (say on a Samsung® Galaxy phone), etc.

Some platforms, such as mobile phones, have limited capabilities and may not be able to render all document formats.

Similarly, different applications used by the recipient, for viewing or editing the document, may have limitations too.

In one example, a PDF format is selected 320 for a recipient who opens the document using a dedicated PC client application, whereas a format suitable for displaying within an Adobe® Flash Player client is selected 320 for a recipient who opens the document using a web application run on a web browser such as Google® Chrome.

The selection 320 of the format may involve identification of a recipient's platform. The format may be identified in a variety of ways.

In one example, the platform is identified using a User-Agent header of an HTTP request, used by a recipient to ask for the document, from which platform information may be extracted.

The User-Agent header may serve for identification of both a client application and a computing device in use by the recipient, as well as of the device's operating system version and capabilities.

In another example, the platform is identified using parameters reported by a client application downloaded to the recipient's device, say by a secure web application tailored specifically for viewing documents distributed to users of apparatus 1000 (i.e. recipients).
A location specific criterion, say that the format is optimal for a specific country that the recipient is located in when the recipient requests the document. For example, documents bearing Japanese fonts may prove problematic when a Microsoft® Word document is sent to a computer located in a country where users are less likely to have Japanese fonts installed on their computers. An image file may serve as a better alternative.

The recipient's location may be extracted using IP Geo Location technologies, or from a recipient's mobile device GPS (Global Positioning System), as known in the art.
A time specific criterion (say that the format is optimal for a predefined time frame, say an editable file for working hours vs. a read-only file for off hours).
An authorization specific criterion (say that the format supports only operations that are within an authorization level assigned to a recipient by the document's sender or by an administrator of the apparatus 1000, say using a GUI).

In one example, a sender may decide that user A (e.g. a recipient who is a trusted partner) may be able to use the document in a non-secured format, while user B (e.g. a recipient who is a new and less trusted partner) may use the document only in a security-enhanced format.

In a second example, an organization may decide that recipients external to the internal computer network of the organization, are not allowed to download any document in a format other than the security-enhanced format. The organization may further dictate that all documents are added recipient specific watermarks (say a watermark with the recipient's name).

Optionally, user identification data (say login data) may form apart of any request to view or download a document. The user identification data may thus be used (in addition, or as alternative to other data, such as IP Addresses or a mail addresses), to extract user permissions, say permissions provided in authorization data received 310 from the sender, as described in further detail hereinbelow.
Other criteria, as described in further detail hereinbelow.

Next, the received 310 document is converted 330 into the one or more formats selected 320 for the recipient(s) of the document, say by the document converter 130, as described in further detail hereinabove.

In one example, the document is converted 330 into the selected format immediately upon receipt 310 of the document, or soon thereafter.

In another example, the document is converted 330 in two stages.

The first stage is performed immediately upon receipt 310 of the document, or soon thereafter. In the first stage, the document is converted 330 into one or more intermediate format(s), say into one or more formats used as a general default which does not depend on any of the criterions described in further detail hereinabove, into several formats that pertain to different platforms, into an intermediate format specific to the selected format, etc.

The second stage is performed only upon receipt of a request to receive the document, from a specific recipient, or upon detection of a specific recipient's attempt to download the document. In the second stage, the document is converted 330 from the intermediate format into the format selected 320 for the specific recipient, as described in further detail hereinbelow.

Optionally, the document is converted 330 into one of the selected 320 formats in parallel to converting 330 the received 310 document into an at least other one of the selected 320 formats, say using the format-specific converters, as described in further detail hereinbelow.

Optionally, as a part of the conversion 330, there are further generated an annotation-free file and one or more respective annotation files (say a different annotation file per each recipient) from the received 310 document. In one example, the annotation-free file includes the received 310 document's content cleaned from annotations and one or more annotation placeholders, as illustrated for an annotation optimized PDF file, using FIG. 5B, and described in further detail hereinbelow.

Similarly, as a part of the conversion 330, there may be further generated a file with one or more watermark placeholders from the received 310 document, say by inserting watermark placeholders at specific parts of the document, as described in further detail hereinbelow.

Optionally, when a specific recipient requests the document, a recipient specific watermark may be placed in one or more of the watermark placeholders, as described in further detail hereinbelow.

Optionally, as a part of the conversion 330, there is further added to the received 310 document, a security layer based on authorization data predefined by the sender, using a GUI. For example, the document converter 130 may further encapsulate the document in a file format in which the content of the document is encrypted and which may be decrypted only using a special, secure web application. The secure web application may be downloaded to the recipient's computing device, as described in further detail hereinabove.

Optionally, the conversion 330 of the received 310 document includes shifting dynamically between two (or more) paths of conversion, say in case of a failure in one of the paths, as described in further detail hereinabove.

Finally, the document converted 330 into the selected 320 format, is distributed 340 to the recipient, say by the document distributer 140, by allowing the recipient to download the converted 330 document, by sending the converted 330 document to the recipient, etc.

Optionally, the document is distributed 340 to the recipient upon the recipient's request (say when the recipient clicks on a link in an email message that the sender sends to the recipient).

Optionally, the document is distributed 340 to the recipient automatically, once the document is converted 330 or later (say as an attachment or a link in an email message), as described in further detail hereinabove.

In one example, a sender wishes to distribute the document to a first recipient who uses a desktop computer and to a second recipient who uses a smart phone, say an iPhone™. Consequently, the document is converted 330 into two different formats: a word document for the first recipient and a PDF file to the second recipient, as selected 330 by the format selector 120, for each respective one of the two recipients.

In a second example, a sender wishes to distribute a textual document to different recipients in the sender's organization.

One of the recipients is a salesperson, who according to information input by an administrator of apparatus 1000, needs to receive each document in three formats: in a PDF format (for printing) with company logo watermarks, in a Microsoft® PowerPoint presentation format, and in an image file format optimal for presentation on a small screen of the salesperson's smart phone.

Another recipient is the sender's secretary who according to information input by the sender, receives all documents in an editable Microsoft® Word format.

Accordingly, upon receipt of a document from the sender, there are selected 320 the three formats for the salesperson, and the document is automatically converted 130 into respective three files, one file in each of the three formats selected 320 for the salesperson. Finally, the three files are sent to the salesperson, thus distributing 340 the document to the salesperson, in the formats selected 320 according to the information input by the administrator.

The conversion 330 of the document to the format selected for the secretary is delayed until the secretary requests the document.

When the sender's secretary requests to download the document from the network computer, the editable Microsoft® Word document format is selected 320 for the secretary. Then, the document is converted 330 into an editable Microsoft® Word document format. Finally, the editable Microsoft® Word document is sent to the secretary, thus distributing 340 the document to the secretary who according to the information input by the sender receives all documents in an editable Microsoft® Word format.

In a third example, a system manager defines that all documents distributed 340 to a recipient in use of a tablet computer, say an iPad™, are distributed 340 in a secured PDF format injected with watermarks bearing the recipient's name, whereas all documents distributed 340 to recipient in use of a desktop computer are distributed in their original format.

Consequently, a document received 310 in a Microsoft Word format, is distributed 340 in the Microsoft Format to Joe who uses a desktop computer, and in a secured PDF format injected with watermarks bearing Mike's name, to Mike who uses an iPad™

Thus, according to an exemplary embodiment, a remote sender (i.e. a user of a computer remote from the networked computer) is allowed to publish documents to one or more remote recipients that need to receive the document in different formats, due to difference in platform, location, etc., as described in further detail hereinabove.

The sender may send 310 the document (say through apparatus 1000) together with a list of authorized recipients, and a set of security definitions such as permissions or restrictions for each of one of the recipients.

Optionally, the received 310 document is converted 330 to multiple file types (for example, a Microsoft® Word document may be converted to a PDF file, a JPEG file, a SWF file, etc), as per a selection 320 based on criterions such as optimization for a specific platform, as described in further detail hereinabove.

A file format may be selected 320 as optimal for a specific platform based on various criteria such as fidelity to a document's original format (i.e. format of the document as received 310), the ability to provide high level security on the platform, the platform's technical limitations, etc., as described in further detail hereinabove.

Optionally, as a part of the conversion 330, the document is further added an additional layer of security, as required by the sender, using authorization data provided by the sender.

The added security may vary from no additional security at all, through adding watermarks or tracking and deterrence measures, to wrapping the entire file in a special format, etc.

Optionally, the special format is a format in which the content of the document is encrypted, and which can be opened only using a specific computer program (say a secure web application or a secure client application) provided by the apparatus 1000. The computer program enforces certain permissions or restrictions as directed by the sender in the authorization data, as described in further detail hereinbelow.

Optionally, the conversion 330 of the received 310 document is carried out using known in the art tools, be it open source software products or commercial software products, available from a variety of vendors such as the Microsoft® Office Suite, or the Image Magic® Suite.

Optionally, the conversion 330 is carried out as a process composed of multiple paths, where each path consists of multiple phases.

In one example's first path, a Microsoft® Office document, presentation or spreadsheet received 310 from a sender, is first converted 330 into a PDF file, using the Microsoft® Office suite. Then, the resultant PDF file is converted 330 into a different format suitable for displaying on an Adobe® Flash based viewer client using an open source program.

In the example's second path, the resultant PDF file is rather converted 330 into a secured PDF file. In the secured PDF file, the document's content is encrypted and added permission related meta-date for each recipient that is allowed to view the file (e.g. ability to print, edit, copy-paste or share the file with others—as defined by authorization data that is provided by the document's sender or by a system administrator). The secured PDF file can be viewed only using a specific secure viewer capable of decrypting the content, and presenting the file while enforcing the permissions in the meta-data.

The example's second path may run in parallel to the first path, as described in further detail hereinbelow.

The conversion 330 may take place either right after the document is received 310, or only upon receipt of a request from an authorized recipient of the document.

Optionally, the conversion 330 process is rather split so that some of the conversion's 330 operations are performed when the document is received 310, and remaining ones of the conversion's 330 operations are performed upon the receipt of the request from the authorized recipient.

In one example, upon receipt 310 of a Microsoft® Word document from User A (a sender), the document is immediately converted 330 into a PDF file (as per a temporary format selection 320 based on the sender's default or a general default format set by a system administrator).

The PDF file is saved in a dedicated database.

When User B—a recipient authorized by the sender, requests to view the document, the conversion 330 of the document continues. The conversion 330 continues by adding an additional layer of security to the PDF file, such as a watermark holding User B's name or a date or time of the recipient's (i.e. User B) request, a password based security mechanism, etc.

Finally, User B is allowed to download the PDF file, thus distributing 340 the document to User B.

Optionally, different ones of the paths may serve as alternative paths of conversion 330, that the conversion 330 can dynamically shift between, say in case of overload or failure in one of the paths, as described in further detail hereinabove.

Optionally, as a part of the conversion 330 of the document to the selected 320 optimal format, after the document is converted 330 to one of the selected 320 formats, the document is encapsulated in a file of a secure format which provides a security mechanism independent of the document's original file format.

For example, the secure format file may be constructed by encrypting the document converted into the selected 320 format, using a strong encryption algorithm, by adding permission related meta-data to the document, etc., as described in further detail hereinabove.

The permission related meta-data may include, but is not limited to: the recipient permissions (say an ability to print, edit, copy-paste the file or share the document's content with others), watermark related information, information usable for identifying and tracking the secure format file's whereabouts, etc., as described in further detail hereinbelow.

Optionally, the secure format files further includes a non-encrypted part which is used similarly to a stub file, and which holds a message displayable by a viewer application in use by a recipient together with links that are usable for downloading an alternative viewer application. The alternative viewer application is capable of decrypting the encrypted document and displaying the content of document.

In one example, the content of the converted 330 document is encrypted and injected into a PDF file, as a block of data.

The same block of data or a second injected block of data further contains permission related meta-data. The blocks of data are injected in a way that does not corrupt the PDF file, say right after the XRef table and before the ‘startxref’ pointer that is usually found at the end of a PDF file. The blocks may also be marked by a special sequence of “magic” bytes that indicate the blocks' presence in the file, say a specific string of digits or other characters.

When a recipient's viewer application opens the PDF file, the application detects the presence of the injected blocks by looking for the “magic” sequence.

Then, the viewer application starts processing the permission meta-data, optionally negotiating keys and license information with the document distributer 140 of apparatus 1000, decrypts the converted 330 document's encrypted content and renders the decrypted content on the recipient's computing device.

Optionally, the selected 320 format is a format optimal for a specific mobile computing device in use by the recipient, thus there may be many device specific formats.

Optionally, each one of the device specific formats is suitable for a different kind of mobile device. Exemplary device specific formats include, but are not limited to: a PDF format with specific fonts, a format consisting of a series of images of pre-rendered pages of the document, and a text-only format of the document.

The device specific formats may also be based on adjustment or optimization of a more general format selected 320 according to a criterion other than the device, say according to the organization of the recipient, the document's time of distribution 340 to a specific recipient, etc., as described in further detail hereinabove.

In a first example, a PDF format is selected 320 for all recipients external to the sender's organization, and a more specific PDF format is selected 320 for a specific device in use by a recipient external to the sender's organization.

The specific PDF format is characterized by further adjustment of the PDF format, so as to shorten loading time or rendering time, to enhance security, to take advantage of device specific features, to improved fidelity, etc. The adjustment may include, but is not limited to: replacing complicated vector drawings with a corresponding bitmap representation, replacing text information with a vector equivalent, adding page thumbnails, adding a text index, adding a table of contents, etc., as known in the art.

Optionally, the conversion 330 further includes indexing the document received 310 from the sender, or any intermediary file of the conversion 330 process, which holds content of the received 310 document. For example, the conversion 330 may include extracting textual content from the received 310 document, and indexing the content using the known in the art open-source Apache Solr project tools.

In one example, the results of the indexing are stored in the converted 330 document itself, thus providing an index in the converted 330 document itself.

In another example, the results are stored on a dedicated database which serves to index all received 310 documents. Consequently, a remote user may submit a query against the dedicated database. If any of the indexed documents matches the query, the document may be distributed 330 to the remote user, provided the user is authorized as a recipient of the document, say by the sender of the document.

Optionally, prior to being distributed 330 the content, the remote user is presented with the bare textual content of the documents that match the query, information such as the document and page where specific content which matches the query appears, paragraph information, etc.

In one example, every document received 310 in one or more specific format(s) (say PDF), is automatically forwarded for textual content extraction, and indexing, say using one of the known in the art open source Apache-Tika project tools.

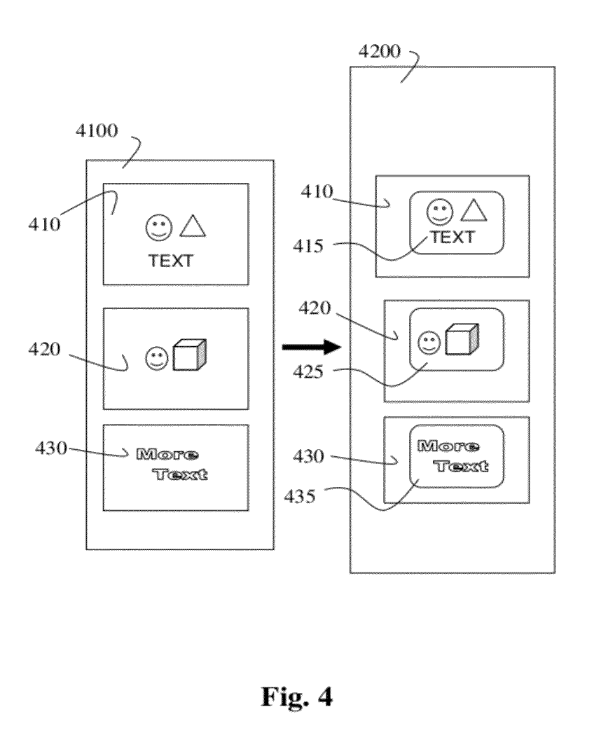

In a second example, illustrated using FIG. 4, an SWF format is selected 320 for all recipients in use of Adobe® Flash Player, and a more specific SWF format is selected 320 for a specific recipient who uses a specific platform, as described in further detail hereinbelow.

Reference is thus made to FIG. 4, which is a block diagram schematically illustrating a document converted into an SWF format, according to an exemplary embodiment of the present invention.

The SWF format is used to render documents in an Adobe® Flash Player based viewer.

An SWF format file 4100 may contain multiple Movieclips. The Movieclips contain the graphical objects used for rendering the document pages. Each Movieclip contains one or more frames, and usually a single document page is mapped to a single frame.

A frame may contain any number of nested Movieclips, in addition to other objects.

The above described structure implies that each SWF file may contain multiple frames 410, 420, 430 that need to be split into individual pages when the file SWF is loaded for rendering and displaying inside an Adobe® Flash Player based viewer.

Unfortunately, a process of splitting the frames 410, 420, 430 into pages may introduce fidelity problems, caused by object alpha masks that are not respected by the Adobe® Flash Player after the objects are copied from the SWF file into in-memory Movieclip objects. Consequently, some objects may extend beyond their boundaries and hide other objects in the page, partially or fully, by covering them.

Optionally, the SWF format selected 320 for the specific recipient, may help overcome the problems.

In the specific SWF format 4200 selected 320 for the recipient, a distinct Movieclip is generated for each file page. The movieclip consists of an additional single frame 415, 425, or 435 that contains all the graphical and textual objects necessary for rendering the page (i.e. the page's entire displayable content) mapped to a respective one of the frames 410, 420, 430.

In order to preserve an ability to search for text within the SWF format file, in addition to wrapping each page's entire displayable content in the single Movieclip, all the text objects in all pages are also copied and grouped together with the Movieclip in a distinct frame, directly under the SWF file's root object. The copied text objects are stored with an attribute of full transparency (and are thus not visible) and are used only for text searching purposes.

Thus, each text object appears in two places: once in the encapsulating Movieclip object, along with the other page objects, and once directly under the SWF file root's object. The SWF file's root object is also a Movieclip.

With reference returned to FIG. 3, it is noted that the document may optionally be received 310 in a file format which includes an inherent mechanism to protect the document's contents, such as password protection, encryption, or other various security settings and restrictions.

Examples for file formats that may contain security mechanisms are the PDF format and various Microsoft® Office file formats. Some other file formats such as TXT files, RTF (Rich Text Format) files and JPEG (Joint Photographic Experts Group) image files, do not contain any inherent security mechanism.

The security mechanism may protect the content of received 310 document from being decoded, parsed, processed or displayed without the knowledge of a secret key or by another protection mechanism. However, the security mechanism may prevent operations necessary for converting 330 the received 310 document into the selected 320 one or more file formats.

In order to convert 330 the received 310 document into one or more of the selected 320 formats, the conversion 330 may further include neutralizing the security mechanisms. Consequently, there may be enabled necessary operations that form a part of the conversion 330 of the received 310 document, say using one or more security mechanism specific neutralizers, as described in further detail hereinabove.

Each security mechanism specific neutralizer enables the apparatus 1000 to deal with a specific protection mechanism, thus enabling the conversion 330 of the document received 310 protected by the security mechanisms.

In one example, the neutralizing of the security mechanisms involves interaction with the sender of a document, for receiving an encryption key, a file password, or whatever other credential needed to successfully open the document (say by decrypting the secured PDF format), for the conversion 330 into the selected 320 formats.

In another example, the neutralizing of the security mechanisms involves notifying the sender that the received 310 document cannot be processed and advising the sender to remove the decryption (say using the password or the encryption key) and resend or upload the document again to the networked computer.

Reference is now made to FIG. 5A which is a block diagram schematically illustrating a document in a PDF file, according to an exemplary embodiment of the present invention.

Optionally, the document received 310 may be a PDF file 510 which has annotations, such as highlighting of text, interactive comments, etc., embedded therein.

A PDF file 510 typically includes a collection of numbered objects 511-517.

Each one of the objects 511-517 represents a different element in the file 510.

For example, each page, drawing, image and font is represented by an object inside the PDF file 510.

The objects 511-517 may also be nested, such that one object may contain one or more references to other objects, or contain the other object itself.

In addition to objects 511-517, the PDF file 510 also contains a table of contents known as the XRef table 518, typically positioned near the end of the PDF file 510.

The XRef table 518 contains a list of all the object 511-518 numbers and their corresponding offsets in the PDF file 510.

Inside the PDF file 510, each annotation is represented as an object, and each page object contains a reference to the page's array of annotations.

PDF viewers which support annotating usually include a feature which allows operations such as creation of new annotations, editing of existing annotations and removal of annotations by manipulating the information within the PDF file 510 directly.

While the feature may work on platforms capable of parsing and rendering PDF files, the feature may be unsuitable for a platform which does not excel at rendering PDF files.

According to an exemplary embodiment of the present invention, as a part of the conversion 330 process, the annotation data is separated from the PDF file 510, thus enabling the operations allowed by the above described feature, on a platform which does not excel at rendering PDF files.

That is to say that the PDF file 510 is separated into a respective annotation-free file and respective one or more annotation files.

The separation of the annotations may also have the advantage of multiple sets of annotations for a single PDF file, say a set of annotation for each recipient or a group of recipients, etc.

For example, upon receiving a request from a recipient in use of a platform which does not excel at presenting annotated PDF files, the recipient may be distributed 340 the annotation-free file and a respective one of the annotation files.

Further, each set of annotation may be assigned different permissions and protection levels, and be maintained separately, in a separate annotation file.

Occasionally, there may be selected 320 a PDF format with annotations, say for a recipient who uses a platform capable of parsing annotated PDF document in format similar to the PDF files 510 of FIG. 5A.

However, the injection of annotations from one of the annotation files into the respective annotation-free PDF file is a repetitive process which may prove computationally expensive, especially in cases where the PDF file is encrypted.

The injection may prove computationally expensive because the injection involves parsing the annotation-free PDF file, loading the objects of the annotation-free file into a computer memory, updating the objects with the annotations, and repetitively manipulating the updated objects, so as to achieve the annotated PDF file, in a format similar to the format of the document in the PDF file 510 of FIG. 5A.

Reference is now made to FIG. 5B which is a block diagram schematically illustrating an annotation optimized PDF file and an index, according to an exemplary embodiment of the present invention.

According to an exemplary embodiment of the present invention, as a part of the conversion 330 process, the PDF file 510 is converted 330 into an annotation optimized PDF file 520, one or more respective annotation files (not shown), and a respective index file 530.

The annotation optimized PDF file 520 is an annotation free file created by removing each page's annotations (if present) from the PDF file 510, storing the annotations in a respective annotation file, and leaving a placeholder 523, 526, in the respective page object 513, 516 of the annotation optimized PDF file 520.

Further generated is an index file 530.

The index file 530 contains annotation indexes that include exact byte offsets of the annotation placeholder 523, 526 of each one of the file page object 513, 516 in the annotation optimized PDF file 520, as well as a copy 538 of the PDF XRef table 518.

Optionally, the index file 530 further contains the byte offset of the XRef table 518 in the annotation optimized PDF file 520, as well as the PDF XRef's table's 518 size.

Using the annotation optimized PDF file 520, together with the respective annotation files and index file 530, injection of annotations may take place in single pass over the annotation optimized PDF file 520, as described in further detail hereinbelow.

Each one of the annotation files may be converted 330 into a PDF annotation format, as known for standard PDF annotation format objects.

Then, the data in the objects of 511-517 of the annotation optimized PDF file 520 is copied in a sequence, until an offset of the annotation placeholder 523 of the first page, as indicated in the index file 530, is reached.

The PDF annotation format file's content for the first page is copied and placed in the placeholder 523.

Going forward, the sequential copying of the data from the annotation optimized PDF file 520 continues, for all the subsequent pages until an offset of another annotation placeholder 526 is reached. In which point, The PDF annotation format file's content for the respective page is copied and placed in the respective placeholder 526.

The sequential copying of the data from the annotation optimized PDF file 520 and annotation format files' content, continues until the XRef data table's 518 offset, as indicated in the index file 530, is arrived at.

Then, the XRef table 538 is copied back to the annotation optimized PDF file 520, line-by-line, from the index. Further, offsets of the objects listed in the XRef table 538 are updated according to their new sizes and offsets, after the annotation placement in the placeholders 523, 526, thus finalizing the annotation insertion process.

Optionally, as a part of the conversion 330, for document security, the document is added watermarks, laid over, below, or in conjunction with the file's original content, as described in further detail hereinabove.

Each watermark may contain information which may identify the document's recipient, the whereabouts of the file, or any information that can help to mitigate risks of file leakage, unauthorized copying or reproduction of the file, or otherwise distinguish between different copies of the document.

Such watermarks may need to be added dynamically, for each specific recipient, upon distribution 340 of the document to the recipient.

The watermark may be added by viewer software in use by the recipient, at the time when the recipient opens the document for viewing. The viewer software needs to be crafted specifically for viewing the watermarks or support scripting in a file format which may need to embed a script that dynamically generates and displays the watermarks when the file is opened.

However, another approach is needed in a case when a recipient downloads the document for viewing in client viewers that cannot add the watermark themselves.

According to on example, the conversion 330 of the document includes generation of a watermark optimized PDF file in a format similar to the annotation optimized PDF file 520. In the example, the conversion further includes generation of the respective index 530, where the placeholders 523, 526 hold places for watermarks rather than annotations, and the respective index 530 points to the placeholders 523, 526, as described in further detail hereinabove.

Before distributing the document to a recipient, the watermark optimized PDF file is added relevant watermarks, in a process similar to the one described for the annotation optimized PDF file 520, in an efficient one pass manner, as described in further detail hereinabove, and illustrated using FIG. 5B.

Reference is now made to FIG. 6 which is a block diagram of a table illustrating division of a conversion process into parallel jobs, according to an exemplary embodiment of the present invention.

Optionally, the conversion step 330 of the exemplary method of FIG. 3 is carried out in two or more jobs that are executed on the networked computer, in parallel.

In one example, the document converter 130 of FIG. 1 converts a document from a PDF format into an SWF format suitable for presentation on an Adobe® Flash Player client, as described in further detail hereinabove, and illustrated using FIG. 4.

The PDF format may be the document's original format (i.e. the format of the document as received) or a format of an intermediate file created in the middle of the conversion process, as described in further detail hereinabove.

In the example, the conversion process is divided into several jobs.

The jobs are executed on the network computer, which in the particular example may be a computer with a multi-core processor, or several computers of which one or more computers may have a multi-core processor, as known in the art.

That is to say that the jobs are run on a network computer capable of parallel processing of the jobs.

The document in the PDF format (i.e. PDF file) is thus divided into several chunks (one chunk for each one of the jobs). Each one of the chunks may consist of one or more pages of the PDF file.

Choosing the correct size for each chunk (and thus the number of parallel jobs) involves a few conflicting factors that may need to be taken into consideration.

Flash Movieclips that are the basis for file representation using an Adobe® Flash Player client are stored in SWF files.

SWF files are inherently optimized for reducing repetition and may thus allow faster download time, better bandwidth utilization and improved CPU and memory usage efficiency. However, since each one of the chunks produces a different SWF file, producing chunks with a small number of pages in order to maximize concurrency of the jobs, may void the advantages inherent to the SWF format.

On the other hand, using bigger chunks may present other problems:

1) Using bigger chunks means that the number of chunks is smaller, thus reducing the possibility of parallelizing the work, and failing to maximize use of the networked computer's computer power. Consequently, efficiency of the overall conversion process may be reduced. Actually, for a big enough chunk, the PDF file is split into a single chunk which contains all the pages of the document, thus failing to achieve any computing concurrency at all.

2) Due to the nature of the Adobe® Flash Player and the SWF format, Flash-based viewer clients may be unable to display the individual pages included in a chunk until the whole chunk is downloaded. This may result in prolonged file loading time and an unpleasant user experience.

According to an exemplary embodiment, the size of the chunks is thus optimized in light of conflicting considerations that have to do with size, conversion concurrency, user experience, etc.

An exemplary method to optimize the division of the PDF document to chunks is based on the following formula which gives the page range of each chunk, in which n denoted the chunk's number:

Chunkₙ={(2ⁿ⁻¹,2ⁿ−1) for n<7

{(64+50×(n−7),64+50×(n−6)−1) for n>=7 Formula 1

For example, if the PDF document contains fifty pages, the conversion is split into nine parallel jobs, with respective nine chunks of different sizes. Each chunk includes a respective page range, as shown in the table 610 illustrated in FIG. 6.

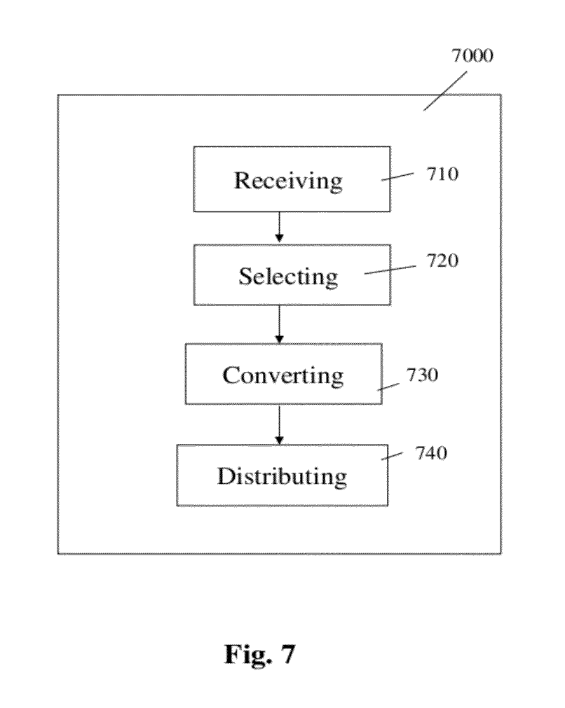

Reference is now made to FIG. 7, which is block diagram schematically illustrating a computer readable medium storing computer executable instructions for performing steps of document distribution, according to an exemplary embodiment of the present invention.

According to an exemplary embodiment of the present invention, there is provided a tangible computer readable medium 7000, such as a CD-ROM, a USB-Memory, a Portable Hard Disk, or a diskette.

The computer readable medium stores computer executable instructions, for performing steps of document distribution, on a networked computer, according to an exemplary embodiment of the present invention.

The computer executable instructions include a step of receiving 710 on a network computer, of a document (say a textual file, a spreadsheet, etc.), from a sender remote from the networked computer (say a user of a desktop computer in communication with the networked computer). The document is received 710, for distribution to users that are authorized to access the document (i.e. authorized recipients), as described in further detail hereinabove.

In one example, the networked computer is an organizational server computer of the sender's organization. In the example, the sender sends the document to the server computer, over the organization's intranet network, together with a list of recipients internal the organization, recipients external to the organization, or both.

In a second example, the networked computer is a server computer of a party that serves as an intermediary between different organizations or computer users. In the second example, the sender sends the document over the internet, to the intermediary's server computer, together with a list of recipients external to the sender's organization.

The computer executable instructions may further include instructions for receiving 710 authorization data.

The authorization data may be input by the sender, by a system administrator, by an authorization officer of the sender's organization, etc., or any combination thereof, say using a Graphical User Interface (GUI), as known in the art.

The authorization data may define one or more authorized recipients remote from the networked computer, as described in further detail hereinabove.

The computer executable instructions further include a step of selecting 720 one or more formats optimal for a specific context in which the document is distributed or supposed to be distributed to a specific one or more of the recipients, according to one or more criterions, as described in further detail hereinabove.

The optimal formats are selected 720 among two or more file formats.

The file formats may differ in file type, such as Microsoft® PowerPoint, Microsoft® Word, Microsoft® Excel, Portable Document Format (PDF), Joint Photographic Experts Group (JPEG), etc. The file formats may also differ in other aspects such as in operations possible with the file format (say a read-only file vs. an editable file), in encryption (or non-encryption) of the format, in watermark data embedded in the format, etc., as described in further detail hereinabove.

The criterions for the format selection may include, but are not limited to:
A sender specific criterion (say that the format belongs to a set of file formats that the remote sender selects or that are selected for the remote sender, say by a system administrator).
A recipient specific criterion (say that that the format belongs to a set of file formats that the remote recipient selects or that are selected for the remote recipient, say by a system administrator).
An organization specific criterion (say that the format belongs to a set of file formats that a system administrator or an authorization officer of an organization selects for the organization of the sender).
A platform specific criterion (say that the format is optimal for a platform in use by the recipient, such as a cellular phone of a specific model, a screen of a specific size, a specific viewer application, or any combination thereof).
A location specific criterion, say that the format is optimal for a specific country that a recipient is located in when the recipient requests the document, as described in further detail hereinabove.
A time specific criterion (say that the format is optimal for a predefined time frame, say an editable file for working hours vs. a read-only file for off hours).
An authorization specific criterion (say that the format supports only operations that are within an authorization level pre-assigned to the recipient by the sender or a system administrator, say in a preliminary stage in which the system administrator defines the authorization level for each user).
Other criteria, as described in further detail hereinabove.

The computer executable instructions further include a step of converting 730 the document into the one or more formats selected 720 for the recipient(s) of the document, as described in further detail hereinabove.

Optionally, the received 710 document is converted 730 into one of the selected 720 formats in parallel to converting 730 the received 710 document into an at least other one of the selected 720 formats, say using the format-specific converters, as described in further detail hereinabove.

Optionally, as a part of the conversion 730, the computer executable instructions further include generating an annotation-free file and one or more respective annotation files (say a different annotation file per each recipient) from the received 710 document. In one example, the annotation-free file includes the received 710 document's content cleaned from annotations and one or more annotation placeholders, as described in further detail hereinabove.

Similarly, as a part of the conversion 730, the computer executable instructions further include generating a file with one or more watermark placeholders from the received 710 document, say by inserting watermark placeholder at specific parts of the document, as described in further detail hereinabove. Optionally, when a specific recipient requests the document, a recipient specific watermark may be placed in one or more of the watermark placeholders, as described in further detail hereinbelow.

Optionally, the computer executable instructions may include instructions for adding to the received 710 document, a security layer based on authorization data predefined by the sender, say using a GUI. For example, the computer executable instructions may include instructions for encapsulating the document in a file format in which the content of the document is encrypted and can be decrypted only using a special web application, as described in further detail hereinabove

The computer executable instructions further include a step of distributing 740 the converted 730 document to the recipient, say by allowing the recipient to download the converted 730 document, by sending the converted 730 document to the recipient, etc.

Optionally, the document is distributed 740 to the recipient upon the recipient's request (say when the recipient clicks on a link in an email message that the sender sends to the recipient).

Optionally, the document is distributed 740 to the recipient automatically, once the document is converted 730 or later (say as an attachment or a link in an email message), as described in further detail hereinabove.

In one example, a sender wishes to distribute the document to a first recipient who uses a desktop computer and to a second recipient who uses a smart phone, say an iPhone™. Consequently, the document is converted 730 into two different formats: an editable word document for the first recipient and a PDF document to the second recipient, as selected 720 for each respective one of the two recipients.

In a second example, a sender wishes to distribute a textual document to different recipients in the sender's organization.

One of the recipients is a salesperson, who according to information input by a system administrator, needs to receive each document in three formats: a PDF format (for printing) with company logo watermarks, a Microsoft® PowerPoint presentation format, and an image file format optimal for presentation on a small screen of the salesperson's smart phone.

Another recipient is the sender's secretary who according to information input by the sender, receives all documents in an editable Microsoft® Word format.

Accordingly, upon receipt of a document from the sender, the three formats are selected 720 for the salesperson, and the document is automatically converted 730 into respective three files, one file in each of the formats selected 720 for the salesperson. Finally, the three files are sent 740 to the salesperson, thus distributing the document to the salesperson, in the formats selected 720 according to the information input by a system administrator.

The conversion 730 of the document into the format selected for the sender's secretary is delayed until the secretary requests the document.

When the sender's secretary requests to download the document from the network computer, the editable Microsoft® Word format is selected 720 for the secretary. Then, the document is converted 730 into the editable Microsoft® Word format. Finally, the editable Microsoft® Word format document is sent to the secretary, thus distributing 740 the document to the secretary who according to the information input by the sender receives all documents in the editable Microsoft® Word format.

It is expected that during the life of this patent many relevant devices and systems will be developed and the scope of the terms herein, particularly of the terms “Computer”, “Networked”, “Internet”, “Intranet”, and “Smartphone”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A computer implemented method for document distribution, the method comprising steps the computer is programmed to perform, the steps comprising:
a) on a networked computer, receiving a document from a sender and authorization data defining at least one authorized recipient for the document, the sender and the authorized recipient being remote from said networked computer;
b) for at least one of the authorized recipients, selecting at least one respective optimal format among a plurality of file formats;
c) converting the received document into the selected format; and
d) distributing the converted document to the authorized recipient.

2. The method of claim 1, further comprising selecting a plurality of formats for said recipient.

3. The method of claim 1, further comprising adding a security layer to the received document.

4. The method of claim 1, wherein said selecting of the optimal format is based on a sender specific criterion.

5. The method of claim 1, wherein said selecting of the optimal format is based on a recipient specific criterion.

6. The method of claim 1, wherein said selecting of the optimal format is based on an organization specific criterion.

7. The method of claim 1, wherein said selecting of the optimal format is based on a platform specific criterion.

8. The method of claim 1, wherein said selecting of the optimal format is based on a location specific criterion.

9. The method of claim 1, wherein said selecting of the optimal format is based on a time specific criterion.

10. The method of claim 1, wherein said selecting of the optimal format is based on an authorization specific criterion.

11. The method of claim 1, wherein said converting is carried out on an organizational server implemented on a networked computer of an organization of the sender.

12. The method of claim 1, wherein said converting is carried out on a server computer of an intermediary party.

13. The method of claim 1, further comprising generating a file with an at least one annotation placeholder, and an at least one annotation file, from said received document.

14. The method of claim 1, further comprising generating a file with an at least one watermark placeholder, from said received document.

15. The method of claim 1, wherein said converting the received document into one of the selected formats is carried out in parallel to converting the received document into an at least other one of the selected formats.

16. The method of claim 1, wherein said converting the received document into one of the selected formats is carried out in at least two steps carried out in parallel.

17. The method of claim 1, wherein said converting the received document into the selected format shifts dynamically between two paths of conversion.

18. The method of claim 1, further comprising neutralizing a security mechanism protecting the content of the received document, prior to said converting of the received document into the selected optimal format.

19. The method of claim 1, further comprising converting the received document into an least one intermediary format before said selecting the optimal format.

20. A computer readable medium storing computer executable instructions for performing steps of document distribution, the steps comprising:
a) on a networked computer, receiving a document from a sender and authorization data defining at least one authorized recipient for the document, the sender and the authorized recipient being remote from said networked computer;
b) for at least one of the authorized recipients, selecting at least one respective optimal format among a plurality of file formats;
c) converting the received document into the selected format; and
d) distributing the converted document to the authorized recipient.

21. An apparatus for document distribution, the apparatus comprising:
a networked computer;
a document receiver, implemented on said networked computer, configured to receive a document from a sender and authorization data defining at least one authorized recipient for the document, the sender and the authorized recipient being remote from said networked computer;
a format selector, in communication with said document receiver, configured to select at least one respective optimal format among a plurality of file formats, for at least one of the authorized recipients;
a document converter, in communication with said format selector, configured to convert the received document into the selected format; and
a document distributer, in communication with said document converter, configured to distribute the converted document to the authorized recipient.

22. The apparatus of claim 21, wherein said document converter is further configured to add a security layer to the received document.

23. The apparatus of claim 21, further comprising a plurality of format-specific converters, in communication with said document converter, wherein each of said format-specific converters is configured to convert the received document into a respective one of said selected formats, and said document converter is further configured to coordinate parallel conversion of the received document by said format-specific converters.
